(19) United States
(12) Patent Application Publication
(10) Pub. No.: US 2015/0081384 A1
(43) Pub. Date: Mar. 19, 2015

(54) DETERMINING LIKELIHOOD OF AN INDIVIDUAL CONSUMER ENROLLING IN A BEHAVIOR-BASED ENERGY EFFICIENCY PROGRAM

(71) Applicant: Fraunhofer USA, Inc., Plymouth, MI (US)

(72) Inventor: Michael Zeifman, Sharon, MA (US)

(73) Assignee: Fraunhofer USA, Inc., Plymouth, MI (US)

(21) Appl. No.: 14/485,290

(22) Filed: Sep. 12, 2014

Related U.S. Application Data
(60) Provisional application No. 61/878,518, filed on Sep. 16, 2013.

(51) Int. Cl. G06Q 30/02

(52) U.S. Cl. CPC G06Q 30/0202
USPC 705/7.31

(57) ABSTRACT

Described herein are various examples of techniques that may be implemented in some embodiments to determine a score indicative of a likelihood of a consumer enrolling in a behavior-based energy efficiency program. The score may be determined based at least in part on prior energy consumption of the consumer. The prior energy consumption of the consumer may be compared to characteristics of energy consumption that were previously determined to be associated with consumers who previously enrolled in an energy efficiency program and consumers who did not previously enroll. Based on the comparison, a score may be determined that the consumer will or will not enroll, or scores of the consumer enrolling and not enrolling may be determined. Based on the score(s), a prediction may be made of whether the consumer will enroll in an energy efficiency program.

### CROSS-REFERENCE TO RELATED APPLICATIONS

The present application claims priority under 35 U.S.C. §119(e) to U.S. Provisional Patent Application Ser. No. 61/878,518, titled “System and method of prediction of household enrollment in energy saving program” and filed on Sep. 16, 2013, the entire contents of which are herein incorporated by reference.

### BACKGROUND

Energy efficiency programs are offered by utility companies, non-profit groups, and others to encourage residential and commercial consumers (collectively referred to as consumers below) of energy sources such as electricity, natural gas, and oil to use energy more efficiently. The programs may be offered to address an ecological goal, such as reducing energy consumption to limit consumption of fossil fuels. The programs may additionally or alternatively be offered to lighten a load on a power grid during a particular time of day, week, or year. The energy-efficiency programs may be offered by these organizations with some sort of measurable result to determine compliance and may include an incentive to consumers to comply such as discounts on energy rates or other incentives.

Some energy efficiency programs may focus on the types of equipment purchased or used by consumers, such as encouraging adoption of more energy-efficient appliances, light bulbs, or other equipment. Other energy efficiency programs include an element based on behavior of consumers related to consumption of energy, such as programs that encourage particular behaviors or changes in behaviors on the parts of consumers. One behavior-based energy efficiency program may, for example, encourage consumers to turn off lights when not needed, while another may encourage consumers to use window-mounted air conditioners less frequently or change a thermostat setting. Some behavior-based programs may have an element that relates to the equipment used by the consumers, such as by encouraging consumers to both use more efficient equipment and to adopt a particular behavior relative to that equipment.

Experience with behavior-based energy-efficiency programs have shown that having consumers engage in or adopt a particular behavior with respect to energy consumption is difficult to achieve, and more difficult to maintain long-term. Additionally, even if an organization is able to persuade a consumer to enroll in a behavior-based energy efficiency program and engage in a behavior, many such consumers stop engaging in the behavior after a time. Typically, in the U.S. only a few percent of a population of consumers may enroll in a behavior-based energy efficiency program.

There are, however, consumers who are willing to join such programs and engage in the incentivized behaviors long-term. Organizations that offer such programs direct their marketing and other enrollment efforts at these consumers. When a behavior-based energy efficiency program is to be offered or is being offered in an area, a group may invest a great deal of resources in identifying likely enrollees in that area. Conventional efforts at identifying such likely enrollees in an area have focused on identifying demographics of prior enrollees in the area or other areas and then identifying consumers with matching demographics in the area.

### SUMMARY

In one embodiment, there is provided a method comprising operating at least one programmed processor to carry out an act of obtaining a plurality of measurements of past energy consumption of a consumer. The plurality of measurements of past energy consumption were measured at a time interval over the time period, where the time interval is one hour or less and the time period is one week or more. The method also comprises operating the at least one programmed processor to calculate, based at least in part on the plurality of measurements, a numeric score for the consumer enrolling in an energy efficiency program, where the energy efficiency program is a behavior-based program that encourages consumers to engage in a behavior relating to energy consumption, and outputting a prediction, determined based at least in part on the score, of whether the consumer will enroll in the energy efficiency program.

In another embodiment, there is provided at least one computer-readable storage medium encoded with executable instructions that, when executed by at least one processor, cause the at least one processor to carry out a method comprising operating at least one programmed processor to carry out an act of obtaining a plurality of measurements of past energy consumption of a consumer. The plurality of measurements of past energy consumption were measured at a time interval over the time period, where the time interval is one hour or less and the time period is one week or more. The method also comprises operating the at least one programmed processor to calculate, based at least in part on the plurality of measurements, a score corresponding to the consumer enrolling in an energy efficiency program. The energy efficiency program is a behavior-based program that encourages consumers to engage in a behavior relating to energy consumption. The method also comprises operating the at least one programmed processor to output a prediction, based at least in part on the score, of whether the consumer will enroll in the energy efficiency program.

In a further embodiment, there is provided an apparatus comprising at least one processor and at least one computer-readable storage medium encoded with executable instructions that, when executed by the at least one processor, cause the at least one processor to carry out a method. The method comprises operating at least one programmed processor to carry out an act of obtaining a plurality of measurements of past energy consumption of a consumer. The plurality of measurements of past energy consumption were measured at a time interval over the time period, where the time interval is one hour or less and the time period is one week or more. The method also comprises operating the at least one programmed processor to calculate, based at least in part on the plurality of measurements, a score indicative of a likelihood of the consumer enrolling in an energy efficiency program. The energy efficiency program is a behavior-based program that encourages consumers to engage in a behavior relating to energy consumption. The method also comprises operating the at least one programmed processor to output a prediction, based at least in part on the score, of whether the consumer will enroll in the energy efficiency program.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustration of an exemplary environment with which some embodiments may operate;

FIG. 2 is a flowchart of a process that a prediction facility may implement in some embodiments to produce a prediction for each of multiple potential enrollees of whether the potential enrollee will enroll in a behavior-based energy efficiency program;

FIG. 3 is a flowchart of a process that a prediction facility may implement in some embodiments to produce a matrix of weights to be used in calculating a score indicative of a likelihood of a consumer enrolling in a behavior-based energy efficiency program;

FIG. 4 is a flowchart of a process that a prediction facility may implement in some embodiments to apply a matrix of weights to produce a prediction for each of multiple potential enrollees of whether the potential enrollee will enroll in a behavior-based energy efficiency program;

FIG. 5 is a flowchart of a process that a prediction facility may implement in some embodiments to select a control group for a research project from a set of consumers who have been determined to be likely to enroll in a behavior-based energy efficiency program; and

FIG. 6 is a block diagram of a computing device with which some embodiments may operate.

### DETAILED DESCRIPTION

The inventor has recognized and appreciated that conventional efforts at identifying the likelihood of an individual consumer enrolling in a behavior-based energy efficiency program are little better than a coin flip. These conventional efforts have focused on demographics. Using such techniques, when a behavior-based energy efficiency program is to be offered or is being offered in an area, one or more demographic characteristics (e.g., age, income, education, presence of children, average energy bill, etc.) associated with prior enrollees in that program are identified. After the characteristics are identified, consumers in the area are evaluated to determine which consumers have matching demographic characteristics and enrollment efforts (e.g., direct mailings) are directed to those consumers with matching characteristics. Because the success of such techniques depends on the strength of the correlation between the identified demographic characteristics and the likelihood of enrollment, a great deal of effort has been invested in such conventional techniques and in identifying the demographics. Despite this, the techniques have a prediction accuracy of little more than 50 percent.

The inventor has recognized and appreciated that these conventional techniques are flawed because the correlation between demographics characteristics and likelihood of enrollment is weak at best. Thus, even with a greater investment of resources in identifying finer-grained demographic characteristics or otherwise attempting to improve the identification of demographic characteristics, these conventional techniques would not reach a prediction accuracy much greater than 50 percent.

The inventor has recognized and appreciated, however, that there is a strong correlation between past energy consumption and likelihood of enrollment in energy efficiency programs. For example, by analyzing past energy consumption of consumers that enrolled and did not enroll in behavior-based energy efficiency programs, energy consumption characteristics can be identified for consumers that enrolled and consumers that did not enroll. Subsequently, energy consumption information for potential future enrollees (e.g., consumers in a new area in which a program is being offered) can be compared to these characteristics to determine whether each consumer better matches the characteristics of the consumers that enrolled or the characteristics of the consumers that did not enroll. The inventor has performed experiments with techniques that use such energy consumption information to determine a scores indicative of likelihoods of consumers enrolling in energy efficiency programs. These experiments show a prediction accuracy of approximately 90 percent—far higher than the 50 percent accuracy achieved with conventional techniques.

The inventor has also recognized and appreciated that multiple mechanisms may be used to produce a prediction of enrollment in a behavior-based energy efficiency program for a consumer based on past energy consumption of the consumer. The inventor has recognized, however, that there are certain computer-implemented mechanisms that may be particularly advantageous in some cases. For example, the inventor has recognized and appreciated the advantages of a prediction facility, executing on one or more computing devices, that calculates a matrix of weight values that correspond to enrollment and non-enrollment of consumers in an energy efficiency program and that, when applied to a matrix of consumption data for the consumers, produces a matrix including two response scores for each consumer, one score corresponding to a likelihood of enrollment by the consumer and the other score corresponding to a likelihood of non-enrollment by the consumer.

Described below are various examples of techniques that may be implemented in some embodiments in a computer-executed prediction facility to determine a score indicative of and corresponding to a likelihood of a consumer enrolling in a behavior-based energy efficiency program. The score may be determined based at least in part on prior energy consumption of the consumer. The prior energy consumption of the consumer may be compared to characteristics of energy consumption that were previously determined to be associated with consumers who previously enrolled in an energy efficiency program and consumers who did not previously enroll. Based on the comparison, a score may be determined that the consumer will or will not enroll, or score of the consumer enrolling and not enrolling may be determined. Based on the score(s), a prediction may be made of whether the consumer will enroll in an energy efficiency program. It should be appreciated, however, that embodiments are not limited to operating in accordance with any of the specific examples below, as other embodiments are possible.

A behavior-based energy efficiency program may be a program that encourages consumers to engage in a behavior with respect to energy consumption. Consumers that are encouraged to engage in the behaviors may be any suitable consumers of energy sources such as electricity, natural gas, oil, etc. For example, a consumer may be a collective term that refers to the occupant(s) of a home, which may be a single person, a family of two or more persons, a group of two or more roommates, or any other people. Each consumer may be associated with one or more accounts with one or more utility companies for purchasing a source of energy, such as purchasing electricity, natural gas, or another form of energy source. In some embodiments, each consumer may be associated with a structure, such as a residence like a home, condominium, or apartment, and the account(s) with the utility company(ies) may be for the provision of energy to produce heat, hot water, cooking heat, light, etc. for that structure.

The behavior that is encouraged by a behavior-based energy consumption program may be any suitable behavior in which a consumer may engage, including behaviors with respect to configuring or operating energy-consuming equipment. Examples of such equipment include HVAC equipment, water heaters, lighting equipment, home appliances, or other equipment that uses energy. Embodiments are not limited to operating with any particular behavior or change in behavior, or any particular equipment.

The behavior that is encouraged by a behavior-based energy consumption program may adjust an energy consumption of a consumer. Any suitable behavior that results in any suitable adjustment to energy consumption may be encouraged in embodiments, as embodiments are not limited in this respect. In some embodiments, the adjustment to energy consumption may result in an overall reduction of energy consumption of the consumer over a time period. In other embodiments, the adjustment may include redistributing energy consumption of the consumer over a time period without reducing, and perhaps even increasing, the overall energy consumption. In other embodiments, the adjustment may include both redistributing energy consumption and reducing energy consumption over a time period, and/or other adjustments to energy consumption.

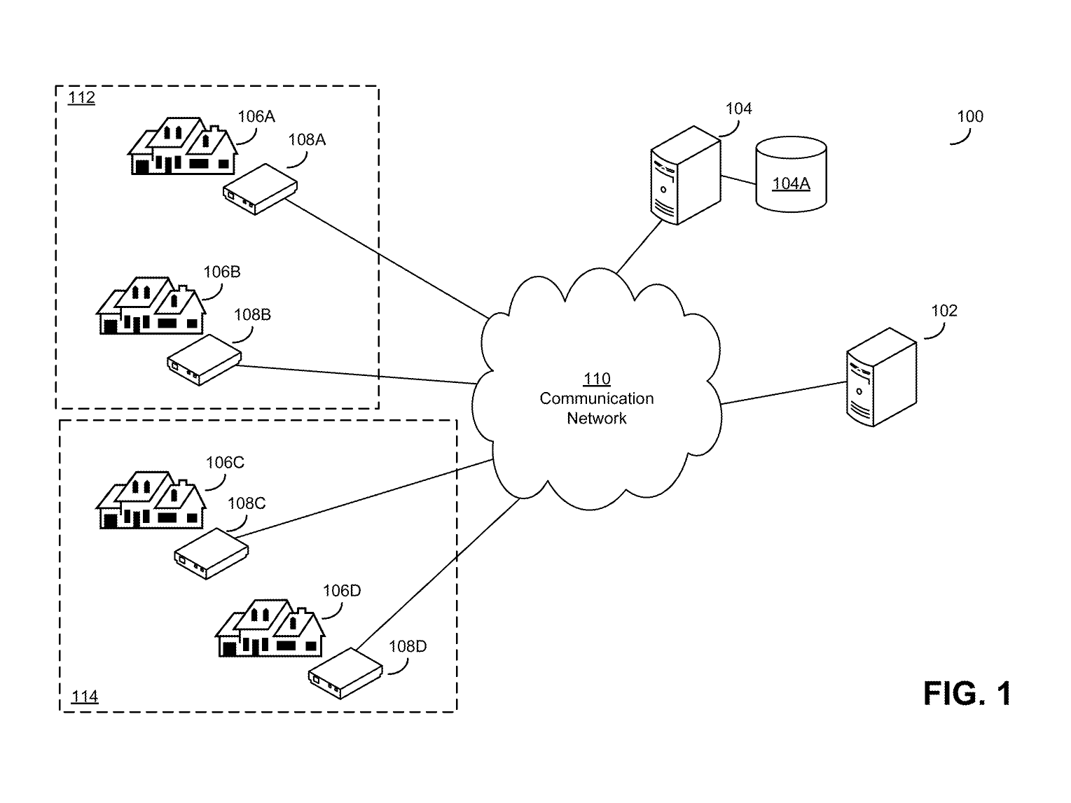

FIG. 1 illustrates an example of an environment 100 in which some of the techniques implemented herein may operate. The environment 100 includes a computing device 102 that executes a prediction facility that may implement any of the techniques described herein to produce a score indicative of a likelihood that a consumer will enroll in a behavior-based energy efficiency program. As should be appreciated from the foregoing, the prediction facility executing on the device 102 processes data regarding consumers, including consumers that previously elected to enroll or not enroll in an energy efficiency program (for ease of description, collectively referred to below as “prior consumers”) and consumers that are potential future enrollees in a program (for ease of description, referred to below as “potential consumers”). In some embodiments, the data regarding both prior and potential consumers may be received from an organization that is administering the energy efficiency program, such as a non-profit group or utility company. The organization may operate a device 104 that stores information regarding the consumers in a data store 104A.

The prediction facility executing on the device 102 may receive the consumer data in any suitable manner, as embodiments are not limited in this respect. For example, in some embodiments the facility may receive the data as input from a user of the device 102 after the user receives the data from the organization operating the device 104. In other embodiments, the device 102 may receive the data electronically from the device 104. For example, in some embodiments the device 102 may have a web interface, an Application Programming Interface (API), or other suitable interface by which to receive data. The device 104 may provide the consumer data to the device 102 via the interface. For example, a user may operate the device 104 and request that the device 104 provide the consumer data via the interface to the device 102.

Upon receipt of the consumer data, the prediction facility executing on the device 102 may perform techniques described herein to train a prediction process implemented by the facility based on data regarding prior consumers and subsequently operate the trained prediction process to produce predictions for potential consumers. The prediction facility 102 may then output the predictions, such as by outputting the predictions to a data store, to a user via a user interface, to the device 104 via an interface, or by outputting in any other suitable manner.

The consumer data that is stored by the device 104 and that may be input to the device 102 may be obtained by the device 104 in any suitable manner, as embodiments are not limited in this respect. In some embodiments, measurement of energy consumption for the consumers (both prior consumers and potential consumers) may be received by the device 104 for residences 106A-106D that are each associated with individual consumers. More specifically, each of the residences 106A-106D may be associated with a consumption meter 108A-108D that measures consumption of energy within an associated residence over a period of time and/or at an instant of measurement by the meter. In some embodiments, the meter may be a meter that makes frequent measurements, such as measurements at a time interval that is less than one hour or less than 30 minutes. In some embodiments, for example, the meters 108A-108D may take measurements every 15 minutes.

Measurements taken by the meters 108A-108D may be communicated to the device 104 via a communication network 110. The communication network 110 may be implemented as any suitable network or combination of networks, and may be a wired and/or wireless network, as embodiments are not limited in this respect. In some embodiments, the network 110 may be or include a wireless wide area network (WWAN) like a cellular network, and in other embodiments the network 110 may be or include a power line network in which data is transmitted via a power grid.

Measurements taken by meters 108A-108D associated with the residences 106A-106D and with consumers may be communicated to the device 104 for billing or other reasons, and may also be used by a prediction facility. The device 104 may store in data store 104A measurements taken by the meters 108A-108D for each of the consumers/residences over a period of time, such as a period longer than one week, longer than one month, longer than six months, or longer than one year, such as a time period between six months and five years. The measurements may be taken by the meters 108A-108D at regular time intervals, which may be any suitable interval such as an interval less than a week, less than a day, less than an hour, or less than 30 minutes, such as an interval between 0 and 30 minutes or an interval of 15 minutes. For example, in one embodiment, the measurements stored in data store 104A for each consumer may include 8,760 measurements for each consumer, representing measurements taken by one of the meters 108A-108D every hour for one year.

As discussed briefly above and as will be further appreciated from the discussion below, in some embodiments the prediction facility executing on the device 102 may be operated in two phases. During a first phase, a prediction process implemented by the prediction facility is trained based on consumer data regarding prior consumers. The consumer data regarding prior consumers may include energy consumption data for each of the prior consumers as well as an indication of whether each of those consumers enrolled in one or more energy efficiency programs. Any suitable number of prior consumers may be used during a training phase, such as between 500 and 5000 consumers that previously enrolled and between 500 and 5000 consumers that previously did not enroll, such as 1000 consumers in each group. During a second phase, the prediction facility operates the trained prediction process on consumer data regarding potential consumers to determine whether the potential consumers may enroll in an energy efficiency program. In some embodiments, the energy efficiency program that the consumer data indicates that the prior consumers enrolled or did not enroll in may be the same program as the one for which a prediction will be made for the potential consumers. In other embodiments, however, the consumer data may indicate enrollment information for a different program (or more than one program) for the prior consumers than the program for which the prediction facility will make a prediction for the potential consumers.

FIG. 1 illustrates the residences 106A-106D for consumers divided into two groups 112 and 114. The group 112 includes prior consumers that were previously given an opportunity to enroll in an energy efficiency program, while the group 114 includes potential consumers that could be given an opportunity to enroll in an energy efficiency program. Consumer data on the group 112 may be used by a prediction facility during a training phase, while consumer data on the group 114 may be used by the prediction facility following training to produce a prediction of whether each consumer of the group 114 will or will not enroll in an energy efficiency program.

Device 102 is illustrated in FIG. 1 as a single server, but it should be appreciated that embodiments are not so limited. In some embodiments, the device 102 may be implemented as set of multiple computing devices, such as multiple servers that share processing resources and tasks, such as a cloud computing platform. In other embodiments, the device 102 may be implemented as a personal computing device such as a desktop personal computer or a smart phone, or other device. Similarly, while the device 104 is illustrated in FIG. 1 as a single server, the device 104 may be implemented in embodiments as any suitable device or set of multiple devices.

Additionally, while FIG. 1 illustrates an embodiment in which a prediction facility is operating on a computing device 102 separate from the device 104 associated with an administrator of an energy efficiency program, it should be appreciated that embodiments are not so limited. It may be advantageous in some embodiments to implement the prediction facility on a computing device 102 that is separate from device 104, because in some embodiments the facility may receive consumer data from multiple different organizations for multiple different sets of consumers and make predictions for multiple different energy efficiency programs that are administered by the different organizations. In other embodiments, however, the prediction facility may make predictions only for energy efficiency programs administered by one organization. In some such embodiments, the prediction facility may be executed by a same device that receives energy consumption measurement data for consumers, and thus may be executed on the device 104 in the example of FIG. 1.

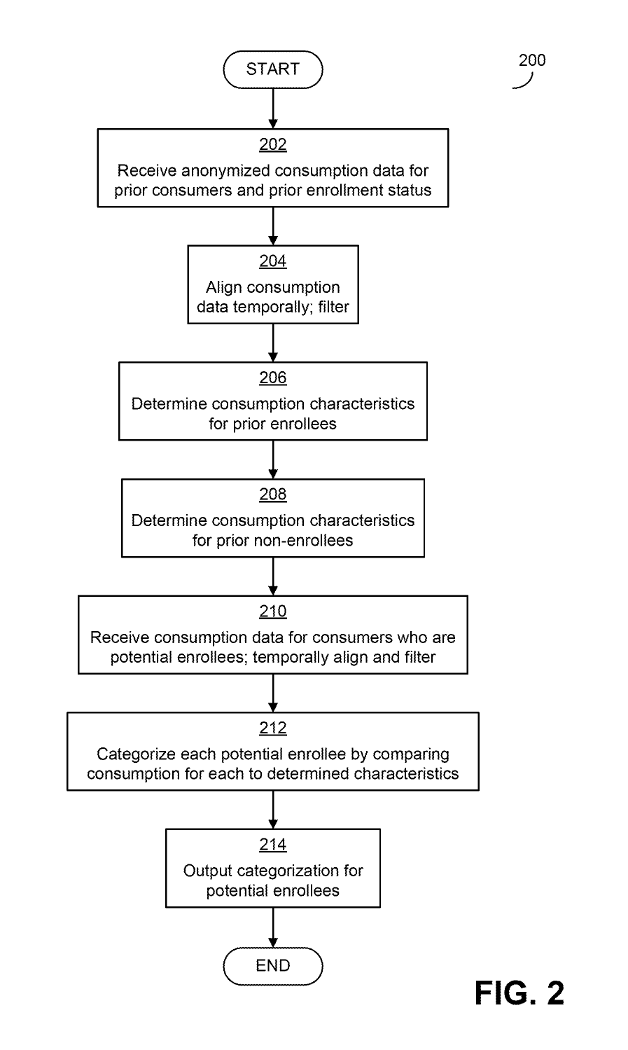

Further details of techniques that may be implemented by a prediction facility will be appreciated from the discussion below of FIGS. 2-5.

FIG. 2 illustrates an overall process 200, including both training and prediction phases, that may be implemented by a prediction facility in some embodiments. Prior to the start of the process 200, measurements of energy consumption for multiple different consumers may have been taken by a meter associated with residences of each of the consumers. The measurements may have been received and stored by a computing device associated with an administrator of one or more energy efficiency programs, such as a non-profit group or utility company. In addition, at least some of the consumers (referred to below as the “prior consumers”) may have been given an opportunity to enroll in one or more of the energy efficiency programs and elected to enroll or not enroll. Other consumers (referred to below as the “potential consumers”) may not have been given an opportunity to enroll in those energy efficiency programs. The process 200 may be used to produce a prediction for each of the potential consumers of whether the consumer will enroll in an energy efficiency program if solicited to enroll.

The process 200 begins in block 202, in which a prediction facility receives energy consumption data for each of the prior consumers, in addition to an indication for each of the prior consumers of whether those consumers have previously enrolled in an energy efficiency program. The energy consumption data may be any suitable data, including the examples of data described above in connection with FIG. 1. For example, the consumption data for each consumer may be a sequence of measurements taken at time intervals over a period of time, such as measurements taken every 15 minutes for one year. Each unit of consumption data may indicate a time of measurement as well as a measurement of consumption at the time the measurement was made. The enrollment indication for each of the prior consumers may indicate whether the consumers have enrolled in a behavior-based energy efficiency program. In some embodiments, the enrollment indication may be an indication of enrollment for multiple different energy efficiency programs, while in other embodiments the enrollment indication may be an indication of enrollment for a single program, which may be the same or different program as the one for which a prediction of enrollment will be produced for potential consumers later in the process 200. For ease of description, the example of FIG. 2 will be described below with respect to a single energy efficiency program for which prior enrollment information is available for prior consumers and for which predictions will be made for potential consumers.

The data may be received in block 202 in any suitable manner, as embodiments are not limited in this respect. In the example of FIG. 2, the data is anonymized such that the data is not associated with any information that may be used to personally identify any of the consumers to which the data corresponds. The data for each consumer may include a unique identifier for the associated consumer. In other embodiments, however, the data may not be anonymized and may include information that may personally identify consumers.

In some embodiments, the consumption data that is received for each consumer in block 202 may relate to different time periods for each consumer, though the time periods may overlap. Additionally, all measurements may not have been made at precisely the same time, or may not have been made based on the same sampling interval. Accordingly, in block 204 the prediction facility temporally aligns and filters consumption data for each consumer to produce a set of consumption data for each of the consumers that covers a same time period and was produced at a same sampling frequency.

In blocks 206 and 208, the prediction facility evaluates the consumption of the prior consumers to produce characteristics of consumption for the consumers. More specifically, in block 206 the facility may evaluate consumption for consumers who previously enrolled in the energy efficiency program to determine consumption characteristics for those consumers, and in block 208 the facility may similarly evaluate consumption for consumers who did not enroll in the energy efficiency program. The characteristics may be any suitable characteristics that differentiate the two groups of consumers from one another. For example, the characteristics may be determined as a set of weighted values that characterize consumption of prior enrollees and non-enrollees and that, when applied to consumption data for a consumer, produce a score indicative of a likelihood that the consumer will enroll and/or a score indicative of a likelihood that the consumer will not enroll in the behavior-based energy efficiency program.

As a result of the determination of characteristics in blocks 206, 208, the prediction facility is configured with information that typifies the energy consumption of both consumers that have previously enrolled in the behavior-based energy efficiency program and consumers that have not previously enrolled in the behavior-based energy efficiency program. During a prediction phase, the prediction facility may use that information to make a prediction of whether a particular consumer that could be solicited to enroll in the program would enroll in the program.

In the example of FIG. 2, the prediction phase begins in block 210, in which the prediction facility receives consumption data for each of multiple potential consumers. The consumption data that is received in block 210 may be received in the same format as the consumption data for the prior consumers was received in block 202 and may be received together with anonymized identifiers for each consumer. In addition, in block 210, the consumption data for the potential consumers may be temporally aligned and filtered in the same manner as in block 204. In some embodiments, the consumption data for each of the potential consumers may cover precisely the same time period as the consumption data for each of the prior consumers and include data produced at exactly the same intervals.

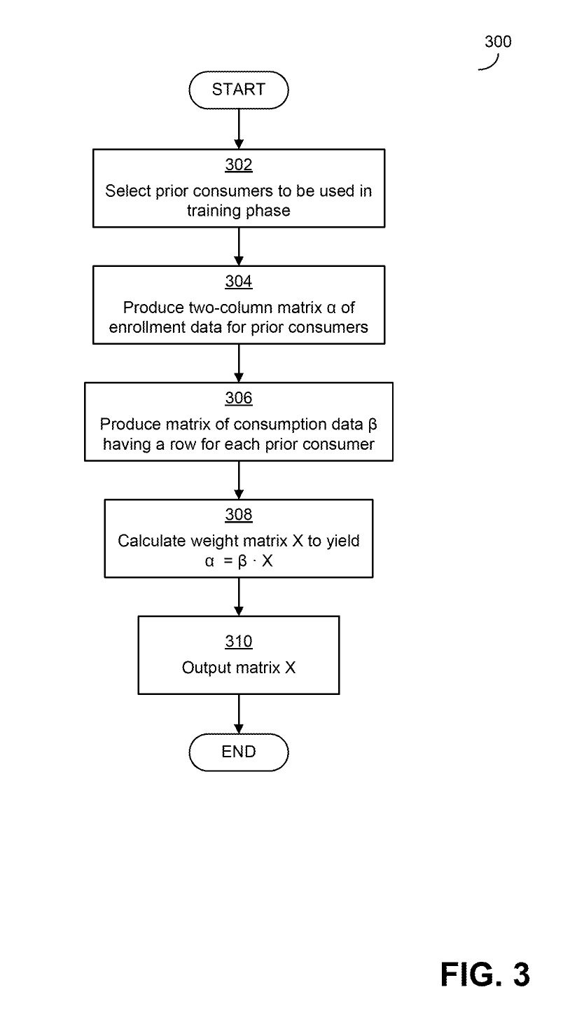

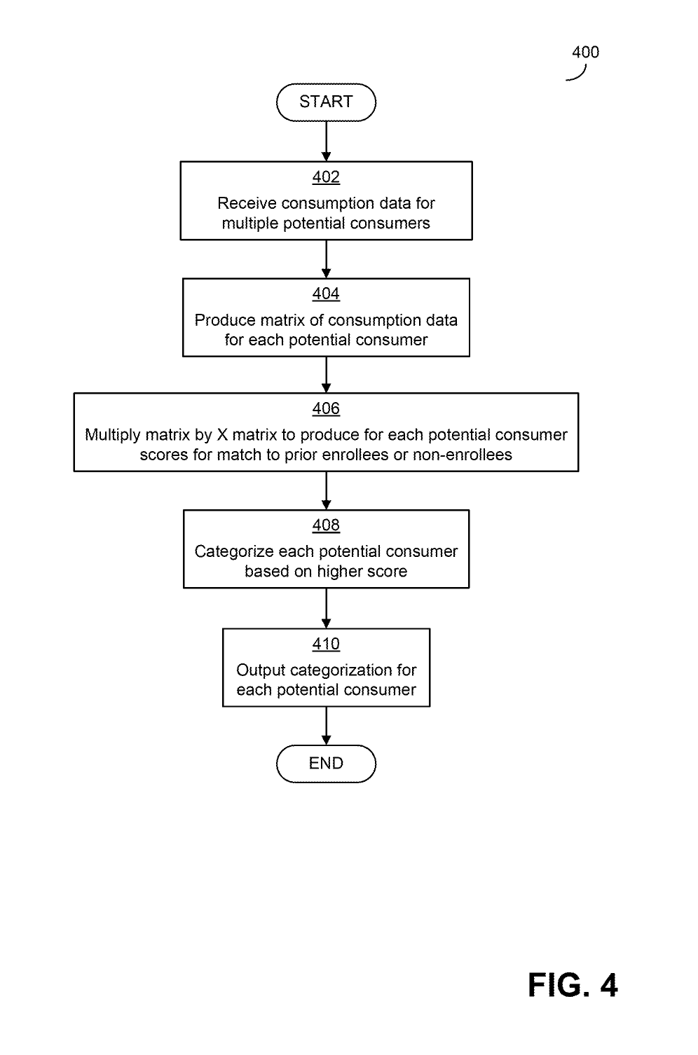

In block 212, using the characteristics for prior enrollees and prior non-enrollees determined in blocks 206, 208, the prediction facility categorizes each of the potential consumers for which data was received in block 210. The prediction facility may categorize the prior consumers in any suitable manner, as embodiments are not limited in this respect. In some embodiments, for example, a set of weights are applied to consumption data for each consumer and produce a score indicative a likelihood of enrollment and/or a score indicative of a likelihood of non-enrollment. In cases in which one or more scores are calculated, the prediction facility may categorize each consumer based on the scores. More details regarding specific examples of ways in which predictions may be generated for consumers will be appreciated from the discussion below of FIGS. 3-4.

In block 214, the prediction facility outputs a categorization of each consumer, which is a prediction of whether each consumer will enroll or not enroll in the behavior-based energy efficiency program. The facility may output the categorizations in any suitable manner, including by outputting for display via a user interface, by writing the categorizations to a data store in any suitable format, by transmitting the categorizations to another computing device, or outputting in any other form. In some embodiments, the categorizations may be output together with an identifier for each of the consumers, such that each consumer and the corresponding categorization may be identified. In embodiments in which the consumption data is received with anonymized identifiers, the prediction facility may output the categorizations in block 214 together with the anonymized identifiers.

Once the categorizations are output in block 214, the process 200 ends. As a result of the process 200, predictions have been made for whether each of the potential consumers for which information was received in block 210 would enroll in the behavior-based energy efficiency program. The predictions may be used to solicit at least some of the consumers who were predicted to enroll in the program. For example, the consumers who were predicted to enroll may be contacted by phone, mail, email, or in-person visits, or contacted in any other way, to inform the consumers of the program and solicit them to enroll in the program. Accordingly, in some embodiments, following the output of predictions together with anonymized identifiers, the anonymized identifiers may be matched back to personally-identifying information for each of the consumers, such that contact information (e.g., phone numbers and addresses) for each consumer may be identified. The information may be de-anonymized in this manner by the administrator of the energy efficiency program, which in some cases may be a utility company of which the consumers are customers, or may be de-anonymized by any other suitable party as embodiments are not limited in this respect.

As discussed above, in some embodiments the prediction facility may, during a training phase, calculate a set of weights that when applied to energy consumption data for a consumer yield a score indicative of whether that consumer will enroll in a behavior-based energy efficiency program and/or a score indicative of whether that consumer will not enroll. In such embodiments, during a prediction phase, those calculated weights may be applied to consumption data for a consumer to yield a prediction for that consumer. FIGS. 3-4 illustrate examples of processes that may be implemented by a prediction facility of some such embodiments during a training phase and during a prediction phase.

Prior to the start of the process 300 of FIG. 3, measurements of energy consumption for multiple different consumers may have been taken by a meter associated with residences of each of the consumers. The measurements may have been received and stored by a computing device associated with an administrator of a behavior-based energy efficiency programs, such as a non-profit group or utility company. The measurement data may have been previously temporally aligned and filtered, such as using techniques discussed above in connection with FIG. 2. In addition, the consumers were given an opportunity to enroll in one or more of the energy efficiency programs and subsequently elected to enroll or not enroll. Data indicating whether each consumer enrolled or did not enroll is also stored along with the energy consumption measurements. Demographic information for each consumer, and each region in which consumers reside, may also be stored in some embodiments. Additionally, the data regarding each consumer may have been anonymized in some embodiments.

The process 300 may be used to train a prediction process of a prediction facility to produce predictions of whether other consumers will enroll in the behavior-based energy efficiency program if solicited. In some embodiments, it may be advantageous to train the prediction process using enrollment information for consumers who are similar to the consumers for which predictions will be made.

Accordingly, the process 300 begins in block 302, in which the prediction facility selects a set of prior consumers to be used in the training phase. The consumers may be selected in any suitable manner, as embodiments are not limited in this respect. For example, when predictions are to be made for consumers who live in a certain area, the prediction process may be trained with information on other consumers who live in that same area. As a specific example, when predictions are to be made for consumers who live in a particular micro-climate zone, the prediction process may be trained with information on other consumers who live in a matching micro-climate zone, or live within the same micro-climate zone.

Though, it should be appreciated that any other suitable set of consumers may be selected in any other suitable manner, as embodiments are not limited in this respect. Further, it should be appreciated that embodiments are not limited to selecting a particular group of prior consumers and other embodiments may operate with any set of consumers selected in any suitable manner.

In block 304, the prediction facility produces a two-column matrix, labeled “a” herein, that includes the enrollment data for each of the consumers selected in block 302. The two-column matrix includes one column for enrollment in the behavior-based energy efficiency program and one column for non-enrollment, and includes as many rows as there are selected consumers. In the matrix, a row for a consumer will include a 1 in the enrollment column when that consumer enrolled in the program and a zero otherwise, and a 1 in the non-enrollment column when that consumer did not enroll in the program and a 0 otherwise. Thus, each row will include one 1 and one 0, with the 1 in the appropriate column to indicate whether that consumer enrolled or did not enroll in the program.

In block 306, the prediction facility produces a matrix, labeled “β” herein, of consumption data for the selected consumers. The matrix may include as many rows as there are consumers, and may include as many columns as there are energy consumption measurements for each consumer. For example, in embodiments in which the energy consumption measurements include one measurement every hour for a full year, the matrix may include 8,760 columns, with one measurement in each column. Thus, each row of the matrix β may include every measurement of consumption included in the received consumption data for the consumer to which the row corresponds.

In block 308, the prediction facility calculates a weight matrix, labeled X, that includes weights that enable the formula α=β·X to be met or approximated within a statistical margin of error that may be chosen by an operator of the prediction facility and that may vary between embodiments and environments. The prediction facility may calculate the weight matrix X in any suitable manner, including using known regression techniques. In some embodiments, the prediction facility may use a particular mathematical procedure of estimation in calculating the matrix X that is a multivariate partial least squares regression (MPLSR), but it should be understood that embodiments are not limited to this particular algorithm or any other particular mathematical algorithm. Other potentially-appropriate mathematical algorithms include but are not limited to CART (classification and regression tree procedure), FDA (flexible discriminant analysis), PDA/Ridge (penalized discriminant analysis with ridge penalty), neural networks with nonlinear regression, and support vector machines.

Those of skill in the art will appreciate that the matrix X will have a two columns of values, with one column corresponding to weights specific to enrollment scores and one column corresponding to weights specific to non-enrollment scores, and will include as many values as there are columns in the matrix β of consumption data. In other words, there will be as many rows in the matrix as there are measurements of energy consumption.

In block 310, once the matrix X is calculated in block 308, the prediction facility outputs the matrix X in any suitable manner, such as by storing the matrix X in a data store accessible by the prediction facility such that the matrix X may be subsequently retrieved and used during a prediction phase. Once the matrix X is output, the process 300 ends.

Following a training phase of operation of a prediction facility, in a prediction phase the prediction facility evaluates consumption data for one or more consumers that may be able to enroll in the behavior-based energy efficiency program to predict whether the consumer(s) will enroll. The consumers may be consumers that may be solicited to join the program, such as consumers that are in an area in which the program is available, newly available, or to be available.

FIG. 4 illustrates an example of a process that a prediction facility may implement in some embodiments to produce the predictions. Prior to the start of the process 400, the prediction facility may have carried out a training phase based on consumption and enrollment data for other consumers, such as the process 300 of FIG. 3. Additionally, prior to the start of the process 400, measurements of energy consumption for each of the consumers for whom predictions are to be made may have been taken by a meter associated with residences of each of the consumers. The measurements may have been received and stored by a computing device associated with an administrator of a behavior-based energy efficiency programs, such as a non-profit group or utility company. The measurement data may have been previously temporally aligned and filtered, such as using techniques discussed above in connection with FIG. 2. Additionally, the data regarding each consumer may have been anonymized in some embodiments.

The process 400 begins in block 402, in which the prediction facility receives energy consumption data for each of the consumers for whom predictions are to be made. In block 404, the facility uses that information to produce a matrix of consumption data for each enrollee. The matrix of consumption data may have a same format as the matrix β discussed above in connection with FIG. 3, with a row for each consumer that includes all of the consumption measurements for each of the consumers.

In block 406, the prediction facility multiplies the consumption matrix produced in block 404 by a matrix X that includes a set of weights. The matrix X may have been created in any suitable manner, including according to user input or according to a training process such as the process 300 of FIG. 3. Multiplying the consumption matrix by the matrix X may yield a new matrix that includes a row for each consumer as well as two columns, respectively associated with scores for enrollment and scores for non-enrollment. The matrix includes, for each consumer, a score corresponding to enrollment and a score corresponding to non-enrollment.

The scores that are determined in block 406 are indicative of likelihoods of enrollment and non-enrollment in that they may be interpreted by the prediction facility to produce predictions of enrollment and non-enrollment. The values of the scores may correspond to likelihood of enrollment or likelihood of non-enrollment in that, as the scores increase, the likelihoods of enrollment or non-enrollment also increase, though an increase in the likelihoods may not be in direct proportion to an increase in the scores.

In block 408, the prediction facility produces such predictions by categorizing each consumer as a consumer who is likely to enroll or likely not to enroll in the behavior-based energy efficiency program based on the scores for each consumer in the matrix calculated in block 406. Specifically, the prediction facility may compare the two scores for each consumer to determine which score is higher and categorize the consumer according to the higher scores. The categories that are produced by the prediction facility in this manner are the predictions of the prediction facility of whether each consumer will or will not enroll in the behavior-based energy efficiency program.

In block 410, the prediction facility outputs the categorization for each consumer. The facility may output the categorization in any suitable manner, including according to examples discussed above in connection with block 214 of FIG. 2. Once the categorizations are output in block 410, the process 400 ends.

In the example of FIG. 4, the prediction facility predicted whether a consumer would or would not enroll based simply on whether the score for enrollment was higher or the score for non-enrollment was higher. It should be appreciated that embodiments are not so limited. In some embodiments, the prediction facility may evaluate the scores to determine whether thresholds are met or exceeded. For example, in some embodiments the prediction facility may additionally or alternatively determine whether a score for enrollment is above a first threshold (e.g., 0.8) and determine that enrollment is likely, regardless of the score for non-enrollment. Similarly, in some embodiments the prediction facility may additionally or alternatively determine whether a score for non-enrollment is above a second threshold (e.g., 0.4) and determine that non-enrollment is likely, regardless of the score for enrollment.

Further, in the example of FIG. 4, the prediction facility outputs a binary conclusion, either prediction of enrollment or a prediction of non-enrollment. In some embodiments, the prediction facility may be configured to output no prediction for a consumer based on the values of the scores of enrollment and non-enrollment. For example, the prediction facility may evaluate the scores for a consumer to determine whether either score meets or exceeds a threshold (which may be the same threshold or different thresholds for the two scores) and, if neither scores meets or exceeds the threshold, may output no prediction for that consumer. As another example, the prediction facility may determine whether the scores for a consumer differ by more than a threshold amount and, if not, may not output a prediction for that consumer regardless of which score is higher.

Additionally, it should be appreciated that while the example of FIG. 4 included calculating two score for both enrollment and non-enrollment, embodiments are not limited to calculating two scores. In some embodiments, one score may be calculated for each consumer and a prediction of enrollment or non-enrollment may be made by the prediction facility based on an evaluation of that score.

The techniques described above may be used to determine consumers to solicit to enroll in a behavior-based energy efficiency program. In some embodiments, once the consumers that are likely to enroll are identified, an administrator of the program may begin soliciting all of the identified consumers to enroll in the program. In other embodiments, however, it may be advantageous not to solicit some of the consumers to enroll in the program. For example, in some embodiments a research study, such as a market research study, a study of program effectiveness, or another research study may be being conducted relative to the behavior-based energy efficiency program. In some such embodiments, it may be valuable to identify a control group for the study that is not permitted to enroll in the program. In these embodiments, it may be valuable to select some consumers who have been predicted to be likely to enroll in the program for inclusion in the control group.

Performing a selection of a control group in this way may be particularly advantageous, as such research studies have conventionally experienced difficulty in selecting a control group with limited or no bias or that does not suffer from other drawbacks. For example, in some prior research studies, consumers who enrolled in a behavior-based energy efficiency program were subsequently assigned to a control group and then informed that they are not permitted to enroll in the program. Such a control group relies on consumers self-selecting themselves for inclusion in the study, in that the consumers first elected to enroll in the program. This may introduce a bias into the study or otherwise influence the results of the study. By selecting consumers for inclusion in a control group from a group that was, using techniques described herein, predicted to be likely to enroll but has not yet been solicited to enroll or has not yet elected to enroll, this source of bias or influence may be eliminated or reduced.

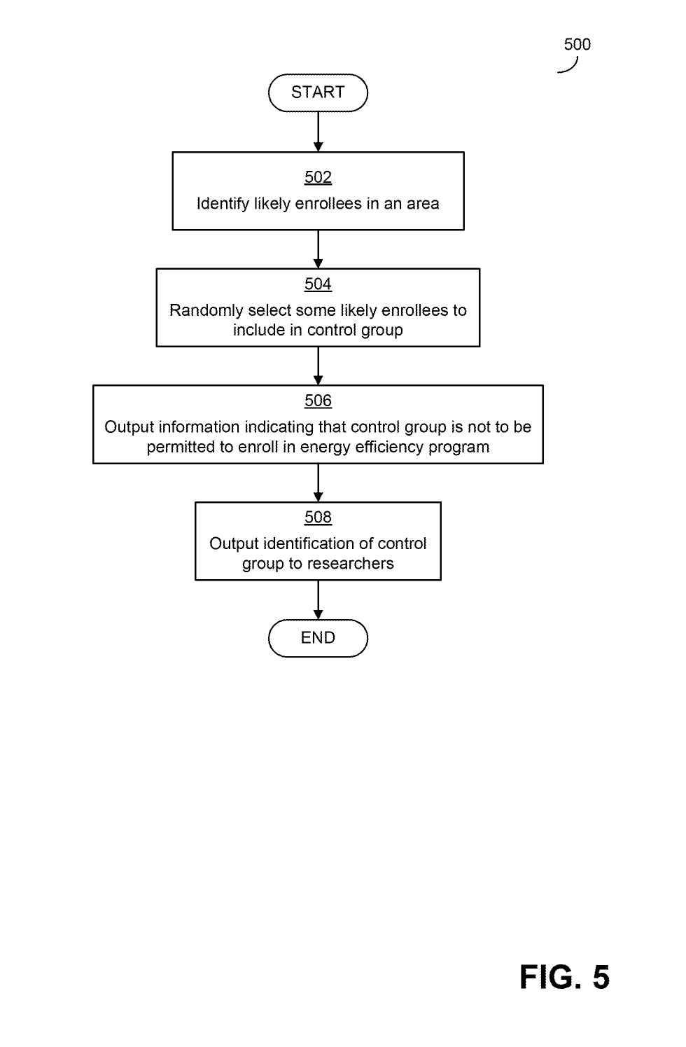

FIG. 5 illustrates an example of a process 500 that a prediction facility may implement in some embodiments to select a control group for a research study. Embodiments are not limited to operating with any particular research study having any particular method or goal, but rather may operate with any research study. Prior to the start of the process 500, the prediction facility may have carried out a training phase based on consumption and enrollment data for other consumers, such as the process 300 of FIG. 3. Additionally, prior to the start of the process 500, measurements of energy consumption for each of the consumers for whom predictions are to be made may have been taken by a meter associated with residences of each of the consumers. The measurements may have been received and stored by a computing device associated with an administrator of a behavior-based energy efficiency programs, such as a non-profit group or utility company. The measurement data may have been previously temporally aligned and filtered, such as using techniques discussed above in connection with FIG. 2. Additionally, the data regarding each consumer may have been anonymized in some embodiments.

The process 500 begins in block 502, in which the prediction facility identifies a set of consumers that are likely enrollees in a behavior-based energy efficiency program. The facility may identify the likely enrollees in any suitable manner, including using any of the examples of techniques described above.

In block 504, the facility randomly (including pseudo-randomly) selects some of the likely enrollees identified in block 502 to include in a control group of the research study and, in block 506, outputs information indicating that the consumers included in the control group are not to be permitted to enroll in the energy efficiency program. Any suitable information may be output in block 506, including an identification of each consumer, which may include an anonymized identifier for each consumer. Additionally, the facility may output the information in any suitable manner, as embodiments are not limited in this respect. For example, the facility may store the information in one or more data stores or output the information for display via a user interface. As another example, the facility may transmit the information to an administrator of the energy efficiency program or to any other suitable party.

In block 508, the facility outputs an identification of each consumer included in the control group to researchers administering the research study. The identification may be the same identification that may have been stored in block 506. The facility may output the identification in block 508 in any suitable manner, including via a user interface or by transmitting the identification to a computing device operated by the researchers. Once the identification is output in block 508, the process 500 ends.

In the example of FIG. 5, the consumers to be included in the control group are randomly selected. Embodiments are not limited to selecting consumers for inclusion in the control group on a purely random basis. In some embodiments, the prediction facility may select consumers having particular demographic characteristics for inclusion in a control group, or may select consumers such that the control group has particular overall demographics. In some embodiments, the prediction facility may divide the likely enrollees into a group to be solicited for enrollment in the program and a control group such that each group has demographics that are the same or similar, or as similar as can be achieved given the demographics of the consumers that have been identified as likely enrollees.

Techniques operating according to the principles described herein may be implemented in any suitable manner. Included in the discussion above are a series of flow charts showing the steps and acts of various processes that determine a score indicative of a likelihood that a consumer will enroll in a behavior-based energy efficiency program. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

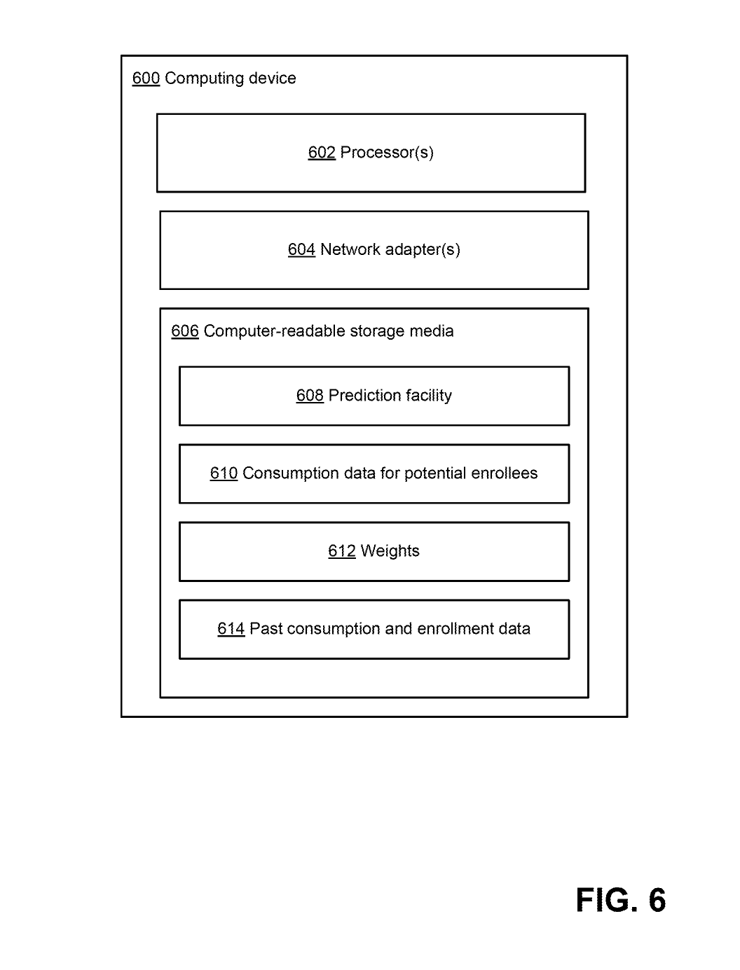

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 606 of FIG. 6 described below (i.e., as a portion of a computing device 600) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 6 illustrates one exemplary implementation of a computing device in the form of a computing device 600 that may be used in a system implementing techniques described herein, although others are possible. It should be appreciated that FIG. 6 is intended neither to be a depiction of necessary components for a computing device to operate in accordance with the principles described herein, nor a comprehensive depiction.

Computing device 600 may comprise at least one processor 602, a network adapter 604, and computer-readable storage media 606. Computing device 600 may be, for example, a desktop or laptop personal computer, a personal digital assistant (PDA), a smart mobile phone, a server, a wireless access point or other networking element, or any other suitable computing device. Network adapter 604 may be any suitable hardware and/or software to enable the computing device 600 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 606 may be adapted to store data to be processed and/or instructions to be executed by processor 602. Processor 602 enables processing of data and execution of instructions. The data and instructions may be stored on the computer-readable storage media 606 and may, for example, enable communication between components of the computing device 600.

The data and instructions stored on computer-readable storage media 606 may comprise computer-executable instructions implementing techniques which operate according to the principles described herein. In the example of FIG. 6, computer-readable storage media 606 stores computer-executable instructions implementing various facilities and storing various information as described above. Computer-readable storage media 606 may store a prediction facility 608 that may implement any of the techniques described above. The media 606 may additionally store data 610-614, including consumption data 610 for potential enrollees, calculated weights 612, and past consumption and enrollment data 614 that may include data that was using in calculating the weights 612.

While not illustrated in FIG. 6, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method comprising:
operating at least one programmed processor to carry out acts of:
obtaining a plurality of measurements of past energy consumption of a consumer, the plurality of measurements of past energy consumption having been measured at a time interval over a time period, the time interval being one hour or less and the time period being one week or more; and
calculating, based at least in part on the plurality of measurements, a numeric score for the consumer enrolling in an energy efficiency program, the energy efficiency program being a behavior-based program that encourages consumers to engage in a behavior relating to energy consumption; and
outputting a prediction, determined based at least in part on the score, of whether the consumer will enroll in the energy efficiency program.

2. The method of claim 1, wherein calculating the score for the consumer enrolling in the energy efficiency program comprises multiplying the plurality of measurements by a plurality of weights, a number of weights in the plurality of weights equaling a number of measurements in the plurality of measurements.

3. The method of claim 2, wherein:
the score for the consumer enrolling in the energy efficiency program is a first score;
multiplying the plurality of measurements by the plurality of weights comprises producing both the first score and a second score, the second corresponding to the consumer not enrolling in the energy efficiency program; and
outputting the prediction comprises outputting a prediction that the consumer will enroll when the first score is greater than or equal to the second score and outputting a prediction that the consumer will not enroll when the first score is less than the second score.

4. The method of claim 3, further comprising:
determining the plurality of weights based at least in part on a plurality of sets of measurements of past energy consumption for a plurality of other consumers and information indicating whether each of the plurality of other consumers previously elected to enroll or not enroll in the energy efficiency program.

5. The method of claim 4, wherein determining the plurality of weights comprises performing a regression analysis.

6. The method of claim 4, wherein determining the plurality of weights comprises applying a mathematical estimation procedure selected from a group consisting of a multivariate partial least squares regression (MPLSR), a classification and regression tree procedure (CART), a flexible discriminant analysis (FDA), a penalized discriminant analysis with ridge penalty (PDA/Ridge), neural networks with nonlinear regression, and support vector machines.

7. The method of claim 4, wherein:
the consumer is one of a plurality of consumers for which a score for enrollment in the energy efficiency program is to be calculated; and
the method further comprises:
repeating the obtaining, calculating, and predicting for each of the plurality of consumers; and
selecting the plurality of other consumers to have characteristics that match the plurality of consumers for which the score for enrollment is to be calculated.

8. The method of claim 7, wherein selecting the plurality of other consumers to have characteristics that match the plurality of consumers comprises selecting other consumers that reside in a same geographic region as the plurality of consumers.

9. The method of claim 7, wherein selecting the plurality of other consumers to have characteristics that match the plurality of consumers comprises selecting other consumers that reside in a second geographic region having a micro-climate that matches that of a first geographic region in which the plurality of consumers reside.

10. The method of claim 7, wherein selecting the plurality of other consumers to have characteristics that match the plurality of consumers comprises selecting other consumers that reside in a same micro-climate as the plurality of consumers.

11. The method of claim 1, wherein:
obtaining the plurality of measurements comprises obtaining a plurality of measurements of electricity consumption produced by an electricity usage meter that is configured to measure electricity consumption and transmit measurements via at least one communication network; and
the time interval is between 0 and 60 minutes and the time period is between six months and five years.

12. The method of claim 11, wherein the time interval is one hour and the time period is one year.

13. At least one computer-readable storage medium encoded with executable instructions that, when executed by at least one processor, cause the at least one processor to carry out a method comprising:
obtaining a plurality of measurements of past energy consumption of a consumer, the plurality of measurements of past energy consumption having been measured at a time interval over a time period, the time interval being one hour or less and the time period being one week or more; and
calculating, based at least in part on the plurality of measurements, a score corresponding to the consumer enrolling in an energy efficiency program, the energy efficiency program being a behavior-based program that encourages consumers to engage in a behavior relating to energy consumption; and
outputting a prediction, determined based at least in part on the score, of whether the consumer will enroll in the energy efficiency program.

14. The at least one computer-readable storage medium of claim 13, wherein calculating the score corresponding to the consumer enrolling in the energy efficiency program comprises multiplying the plurality of measurements by a plurality of weights, a number of weights in the plurality of weights equaling a number of measurements in the plurality of measurements.

15. The at least one computer-readable storage medium of claim 14, wherein:
the score corresponding to the consumer enrolling in the energy efficiency program is a first likelihood;
multiplying the plurality of measurements by the plurality of weights comprises producing both the first score and a second score, the second score corresponding to the consumer not enrolling in the energy efficiency program; and
outputting the prediction comprises outputting a prediction that the consumer will enroll when the first score is greater than or equal to the second score and outputting a prediction that the consumer will not enroll when the first score is less than the second score.

16. The at least one computer-readable storage medium of claim 15, wherein:
the consumer is a first consumer and the plurality of measurements is a first plurality of measurements;
the first consumer is one of a plurality of consumers for which a score corresponding to a likelihood of enrollment in the energy efficiency program is to be calculated, each one of the plurality of consumers being associated with one of a plurality of sets of measurements of past energy consumption of the one of the plurality of consumers, each of the plurality of sets of measurements having a same number of measurements and indicating consumption of a same time period, the first plurality of measurements being one of the sets of measurements of the plurality of sets of measurements; and
calculating the score corresponding to the first consumer enrolling in the energy efficiency program comprises calculating a score corresponding to a likelihood of enrollment in the energy efficiency program for each of the plurality of consumers, wherein calculating the score corresponding to likelihood of enrollment for each of the plurality of consumers comprises:
producing a first matrix having a number of rows that correspond to a number of the plurality of consumers, where each row of the first matrix includes one of the plurality of sets of measurements of past energy consumption; and
multiplying the first matrix by a second matrix including the plurality of weights to produce a third matrix, the third matrix including for each of the plurality of consumers a first score corresponding to a likelihood of enrolling in the energy efficiency program and a second score corresponding to a likelihood of not enrolling in the energy efficiency program.

17. An apparatus comprising:
at least one processor; and
at least one computer-readable storage medium encoded with executable instructions that, when executed by the at least one processor, cause the at least one processor to carry out a method comprising:
obtaining a plurality of measurements of past energy consumption of a consumer, the plurality of measurements of past energy consumption having been measured at a time interval over a time period, the time interval being one hour or less and the time period being one week or more; and
calculating, based at least in part on the plurality of measurements, a score indicative of a likelihood of the consumer enrolling in an energy efficiency program, the energy efficiency program being a behavior-based program that encourages consumers to engage in a behavior relating to energy consumption; and
outputting a prediction, determined based at least in part on the score, of whether the consumer will enroll in the energy efficiency program.

18. The apparatus of claim 17, wherein calculating the score indicative of the likelihood of the consumer enrolling in the energy efficiency program comprises multiplying the plurality of measurements by a plurality of weights, a number of weights in the plurality of weights equaling a number of measurements in the plurality of measurements.

19. The apparatus of claim 18, wherein:
the score indicative of the likelihood of the consumer enrolling in the energy efficiency program is a first score;
multiplying the plurality of measurements by the plurality of weights comprises producing both the first score and a second score, the second score being indicative of a likelihood of the consumer not enrolling in the energy efficiency program; and
outputting the prediction comprises outputting a prediction that the consumer will enroll when the first score is greater than or equal to the second score and outputting a prediction that the consumer will not enroll when the first score is less than the second score.

20. The apparatus of claim 17, wherein the method further comprises:
randomly determining whether to place the consumer in a control group for a research project; and
in response to determining that the consumer is to be placed in a control group for a research project, outputting an indication that the consumer is not to be permitted to enroll in the energy efficiency program.
